(19) United States
(12) Patent Application Publication
(10) Pub. No.: US 2008/0154698 A1
(43) Pub. Date: Jun. 26, 2008

(54) DYANMIC PRODUCT CLASSIFICATION FOR OPINION AGGREGATION

(75) Inventors: Gary W. Flake, Bellevue, WA (US); Lili Cheng, Bellevue, WA (US); David M. Chickering, Bellevue, WA (US); Michael Connolly, Seattle, WA (US); Alexander G. Gounares, Kirkland, WA (US); Kamal Jain, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/862,683

(22) Filed: Sep. 27, 2007

Related U.S. Application Data
(60) Provisional application No. 60/870,926, filed on Dec. 20, 2006.

(51) Int. Cl. G06F 17/30

(52) U.S. Cl. 705/10

(57) ABSTRACT

The claimed subject matter relates to an architecture that can utilize features of a product to facilitate organization and/or classification of products or product features as well as opinions relating to those products or product features into market identifiers. The market identifiers can aid in aggregating opinions in a more relevant manner that potentially requires less user information about a user in order to achieve bone fide targeting. The architecture can employ data mining techniques to gather information relating to products and opinions thereof in order to create or update data tables and can further allow a user to configure the market identifier in various ways.

### CROSS-REFERENCE TO RELATED APPLICATIONS

This application claims the benefit of U.S. Provisional Application Ser. No. 60/870,926, filed Dec. 20, 2006, entitled “ARCHITECTURES FOR SEARCH AND ADVERTISING.” This application is related to U.S. application Ser. No. 11/769,449, filed on Jun. 27, 2007, entitled “NETWORK-BASED RECOMMENDATIONS,” related to U.S. application Ser. No. 11/769,439, filed on Jun. 27, 2007, entitled “MARKET SHARING INCENTIVES,” and related to U.S. application Ser. No. 11/765,685, filed on Jun. 20, 2007, entitled “VIRTUALIZING CONSUMER BEHAVIOR AS A FINANCIAL INSTRUMENT.” The entireties of these applications are incorporated herein by reference.

### BACKGROUND

Conventionally, opinions or recommendations from third parties can play a decisive role in an individual's subsequent transactions (e.g. purchases), but it is generally agreed that, while very useful, there are certain limitations inherent in opinions, namely that all individuals differ in some ways. Accordingly, without knowing those differences in advance, an opinion is either hit or miss. For example, consumer A may choose a mechanic or visit a particular website based upon a recommendation or opinion from consumer B. Due to intrinsic differences or similarities, consumer B's opinions may or may not be appropriate for consumer A, or even more generically, some other individual. Accordingly, conventional systems that employ opinion data to provide recommendations tend to aggregate numerous opinions in some way in order to provide a more generalized opinion for the product that, on average, can be more useful to any given (random) individual.

While aggregating opinions is, on average, more useful than a single opinion, to any given person, it is still more generalized and, therefore, less specific or tailored to any one person. Thus, conventional systems that aggregate opinions tend to gain in overall accuracy versus a randomly selected opinion, but this accuracy gain still falls far short of true personalization. One well-known response to this difficulty is to aggregate opinions over a particular subclass of people specific to an individual rather than over all people. For example, certain conventional systems provide recommendations for a product by way of the product itself such as “if you enjoy product A, you will likely enjoy product B” or “customers who purchased product A also purchased product B”. As another example, if the system is fortunate enough to have access to information such as demographic data, histories, or friend lists, the aggregations control group can be similar to “people like you tend to like product A” or “here are the opinions of people from your friend list relating to product B”.

While the foregoing examples might provide a weak form of personalization by aggregating opinions over a potentially unique set for each customer, it is arguable whether or not such personalization is worthwhile. For example, even though customer A and customer B might be close friends, one may not share the other's taste in website consumption or mechanics. Thus, customer A may disagree with one or both opinions about the mechanic or the website. On balance customer A might value the mechanic, but disapprove of the website, indicating that customer B's opinion, even though a friend, is no more accurate than an opinion from a random person and/or that opinions aggregated across numerous friends are no more accurate than those aggregated across the population at large. Hence, the potential power of true tailoring, targeting, and/or personalization is not necessarily realized by this approach.

In addition, this approach often requires enormous amounts of personal information, and there has historically been a continuous struggle between advertisers and consumers with respect to sharing information. On the one hand, by acquiring information relating to the consumer, the advertiser can tailor ads or opinions to be appropriate for the consumer, which, ultimately, can be beneficial for all parties involved. However, on the other hand, advertisers always want to reach consumers, yet oftentimes a consumer does not want to be bothered by the advertiser. Thus, many consumers simply refuse to sanction many types of information sharing. Hence, the personal information required by this approach can be quite difficult to obtain, even though the application of such conventionally provides only marginal benefits.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one aspect thereof, comprises a computer implemented architecture that can employ product (or a product feature) classifications in order to aggregate opinions associated with a product. The aggregated opinions can be much more relevant to an end user based upon the notion that certain products or features thereof lend themselves well to one or another type of opinion and may very well preclude the usefulness for a different type of opinion. For example, aggregating opinions only from friends may be useful in certain product domains but be of virtually no worth (e.g., perform no better than an opinion selected at random) in other product domains.

For instance the opinion of a friend might be very useful for domains or products with features that relate to a risk of defection or an issue of trust such as an auto mechanic, but of little use for features or market niches that relate to personal tastes or technical expertise given that these factors do not tend to be a factor in friendships, whereas trust issues often are. Moreover, by employing products/features to determine an appropriate data set for relevant opinions, the selected opinions can be effectively personalized and, given that one emphasis is on product information (which is often much more readily obtainable than personal user data), such personalization can be achieved at a much lower cost.

To these and other related ends, the architecture can receive a query from a user, classify the query into one or more market identifier(s) (e.g., “friends,” “experts,” etc.) based upon the features of the product cited in the query, and return a set of opinions that have been categorized by the same market identifier(s). In accordance therewith, the architecture can also employ comprehensive data mining techniques to build data tables relating to the characterization of products/features vis-à-vis the market identifiers.

According to an aspect of the claimed subject matter, the architecture can be implemented in connection with web browsers and/or Internet search engines to provide not only the opinions determined to be more relevant, but to provide a mechanism to modify search results based upon the relevant set of opinions. Moreover, a user interface can be provided to allow the user to alter the market identifier in order to receive different sets of results, one for each market identifier or each combination of market identifiers according to fully configurable weighting parameters.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a block diagram of a computer implemented system that can employ product classifications to aggregate opinions associated with a product.

FIG. 2 depicts a block diagram illustrating various examples of a market identifier.

FIG. 3 is a block diagram depicting a number of example product features that can be identified and/or utilized to determine market identifier.

FIG. 4 illustrates a block diagram of a system that can construct market identifiers and/or provide alternative opinion sets.

FIG. 5 depicts a block diagram of a computer implemented system that can aid with various inferences.

FIG. 6 is an exemplary flow chart of procedures that define a computer implemented method for aggregating opinions relating to a product based upon market categories.

FIG. 7 illustrates an exemplary flow chart of procedures that define a computer implemented method for acquiring opinions and constructing a data table suitable for identifying market identifiers.

FIG. 8 depicts an exemplary flow chart of procedures defining a computer implemented method for providing additional aspects or features.

FIG. 9 illustrates a block diagram of a computer operable to execute the disclosed architecture.

FIG. 10 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, or the like can refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

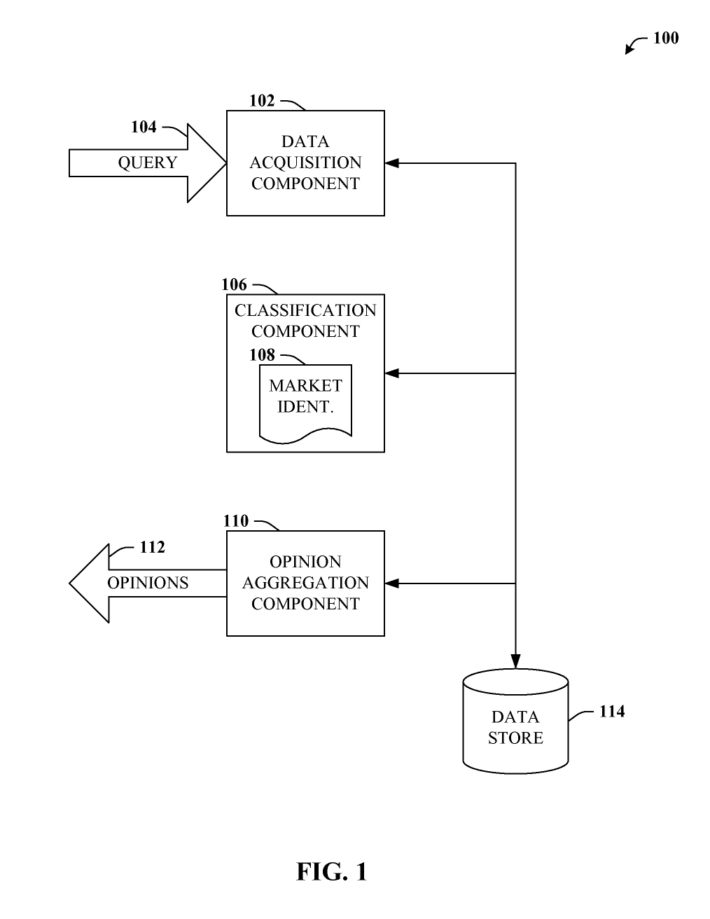

Referring now to the drawing, with reference initially to FIG. 1, computer implemented system 100 that can employ product classifications to aggregate opinions associated with a product is depicted. Generally, system 100 can include data acquisition component 102 that can receive query 104. According to one aspect, data acquisition component 102 can be associated with or a component of an Internet search engine. Similarly, data acquisition component 102 can exist on a client device and/or be resident in an application, utility, browser, gadget and so forth. Typically, query 104 is received from a user (not shown) of system 100 and is generally associated with a product. A product, as used herein, can denote substantially any good (e.g., a camera or book) or service (e.g., automobile repair or brokerage service). In addition, in some cases, a product can also refer to a suggestion or experience (e.g., travel destination or how-to guide) an investment opportunity (e.g., real estate or securities tips) or substantially any knowledge-based asset. Accordingly, a product can be but need not necessarily be restricted to only goods or services that are exchanged for value. Rather, a product can be informational in nature and/or freely available for consumption.

In addition, system 100 can include classification component 106 that can be operatively coupled to data acquisition component 102. Classification component 106 can determine market identifier 108 based at least in part upon a feature of the product. Market identifier 108 can be a classification (for the product) in which an opinion for or about the product is relevant, and is described in more detail infra. Market identifier 108 can be the classification that is most relevant as well as one of several classifications that are relevant, either independently or in association with other market identifiers 108 or product features. It is to be understood that the term “opinion,” as used herein can relate to opinions, recommendations, ratings, scoring, reviews, descriptions, and so forth.

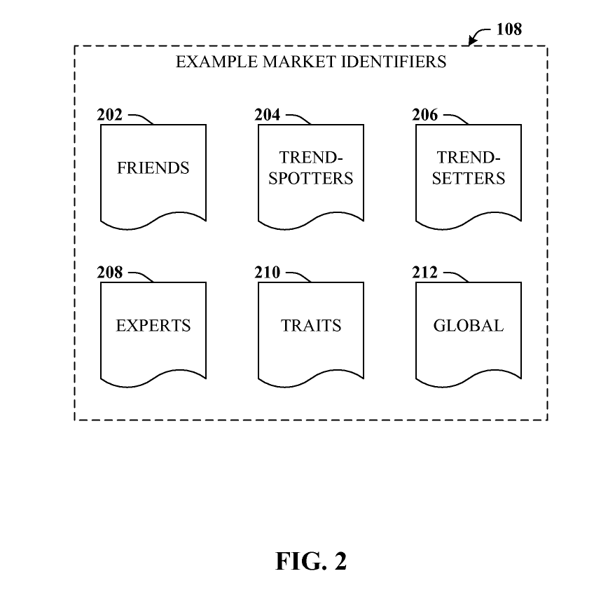

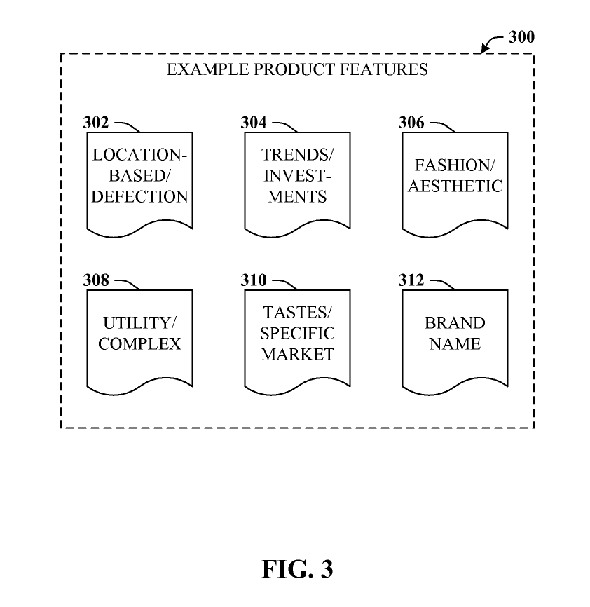

System 100 can also include opinion aggregation component 110 that can select a set of opinions 112 related to market identifier 108. This selection can be based upon information associated with the user, which at a minimum can be data included in query 104 such as that the user desires information about the cited product. Further information about the user may be required for other market identifiers 108. For instance, in order to aggregate opinions of a user's friends, a set of friends might be necessary information about the user. More on this topic can be found infra, however, it should be underscored here that both information associated with the user and market identifier 108 can play a role in selecting the set of opinions 112. For example, market identifier 108 can define which opinions are available to include in set 112, while the user information can be employed by opinion aggregation component 110 to determine which of those available opinions should be selected. In order to provide further context in connection with market identifier 108 and product features, FIGS. 2 and 3, respectively, can be referenced along side of FIG. 1 before continuing the discussion of FIG. 1.

Turning now to FIG. 2, various examples of market identifier 108 are provided, while FIG. 3 illustrates a number of example product features 300 that can be identified and/or utilized to determine market identifier 108. It is to be appreciated that the examples indicated in FIGS. 2 and 3 are not intended to be exhaustive but rather to provide comprehensive and concrete illustrations without necessarily limiting the scope of the claimed subject matter to only one or more of the enumerated examples. Thus, other examples are contemplated to exist that can be implemented in accordance with the disclosed subject matter and the appended claims.

In order to provide additional context, it is well known that opinions or recommendations from others can play a decisive role in an individual's future transactions (e.g., purchases), but also known that there are certain limitations inherent in opinions, namely that all individuals differ in some ways so without knowing those differences in advance, an opinion is either hit or miss. For example, Ashley may choose a mechanic or visit a particular website based upon a recommendation or opinion from Ross. Due to intrinsic differences or similarities, Ross's opinions may or may not be appropriate for Ashley, or, more generically, some other individual. Accordingly, conventional systems that employ opinion data to provide recommendations tend to aggregate numerous opinions in some way in order to provide a more generalized opinion for the product that, on average, can be more useful to any given (random) individual.

While aggregating opinions is, on average, more useful than a single opinion, to any given person, it is still more generalized and, therefore, less specific or tailored to any one person. Thus, conventional systems that aggregate opinions tend to gain in overall accuracy, but at the cost of personalization, which is also an important factor in an individual's transaction decisions and generally far, far more predictive. One well-known response to this difficulty is to aggregate opinions over a particular subclass of people specific to an individual rather than over all people. For example, certain conventional systems provide recommendations for a product by way of the product itself such as “if you enjoy product A, you will likely enjoy product B” or “customers who purchased product A also purchased product B”. As another example, if the system is fortunate enough to have access to information such as demographic data, histories, or friend lists, the aggregations control group can be similar to “people like you tend to like product A” or “here are the opinions of people from your friend list relating to product B”.

While the foregoing examples do provide a form of personalization by aggregating opinions over a potentially unique set for each customer, it is arguable whether or not such personalization is worthwhile. For example, even though Ashley and Ross are close friends, she may not share his taste in website consumption or mechanics. Thus, Ashley may disagree with one or both opinions about the mechanic or the website. On balance Ashley might value the mechanic, but disapprove of the website, indicating that Ross's opinion, even as a friend, is no more accurate than an opinion from a random person and/or opinions aggregated across numerous friends are no more accurate than those aggregated across the population at large. Hence, the potential power of personalization is not necessarily realized by this approach.

In order to address these issues, the claimed subject matter can aggregate a potentially unique set of opinions (e.g., opinions 112) for a given user based not only upon information associated with the user; based not only upon the product itself, but also based upon various features of the product. As an example, given the scenario above, one reason Ashley might value the mechanic but disapprove of the website recommendation from Ross is likely due to the fact that Ashley and Ross share some similarities, but not others, as is the case when comparing Ashley to any given third person. Rather than focusing on differences or similarities between certain individuals, which can require an enormous amount of data that is often difficult if not impossible to attain, it can be suggested that there are features that distinguish various products, and such features can be identified and/or employed to provide more personalized (and therefore more accurate) recommendations or opinions 112. Hence, it should be underscored that by employing features of the product to in order to select opinions 112, one potentially unforeseen benefit is that less background or profile information about a user might be required in order to tailor or personalize opinions 112 to a particular user given that such information can be substituted by information acquired, determined, or inferred about a product or product feature.

As a result, very broadly and as it applies to Ashley, Ross's opinions can be aggregated for mechanics, but not for website consumption, and such an aggregation can often occur without the need for detailed personal information from both parties. Rather, the above can be achieved by employing market identifiers 108 noted supra. More specifically, rather than attempting only to classify or categorize individuals in order to predict behavior or likely transactions, the claimed subject matter can classify the products themselves (by way of market identifiers 108) and provide personalization for any given user based upon the product type or category. Thus, features associated with the product can be employed to estimate whether Ashley and Ross will share similar interests in products instead of simply the notion that such is the case merely because Ashley and Ross are friends. In other words, it should be appreciated that any given product (e.g., referenced by query 104) will typically have one or more features that make some opinions or recommendations more relevant and/or some opinions or recommendations irrelevant.

In accordance therewith, a more appropriate or more personalized set of opinions 112 can be selected based in part upon characteristics of the domain or niche of the underlying product. This domain or niche as well as the indicated characteristics or features can be distinguished and/or represented by market identifier 108. One example market identifier 108 can be friends 202. While friends 202 (as well as any other market identifier) might not be any more or less accurate than a random opinion, there are certain product domains and/or product features in which ones friends are very good sources of reliable opinions. For example, Ashley may trust Ross's opinion for a mechanic, but not for, say, a bottle of wine. Opinions from friends 202 are typically more relevant for products that have features associated with trust, products that are location-based, or products in which there is a risk of defection as indicated by example product features 300 at reference numeral 302. Accordingly, classification component 106 can determine that friends 202 is the most relevant market identifier 108 for aggregating opinions when query 104 relates to a product that has features associated with location/trust/risk of defection 302, such as, e.g., an automobile mechanic. Furthermore, opinion aggregation component 110 can further refine the selection of opinions 112 based upon information associated with the user, such as friends 202 that are specifically associated with the user.

Another example market identifier 108 can be trendspotters 204. As detailed herein, some individuals are endowed with an ability to be trendspotters 204, while many other individuals are substantially trend followers. For example, trend followers tend to be interested in goods or services that are already popular or share a substantial amount of commercial success, whereas trendspotters 204 have a knack for ferreting out a product well in advance of the popularity or success the product later attains. Across disparate categories, an individual may behave as one or the other or a combination of the two. For instance, when buying movies released on digital versatile disc (DVD), the individual may substantially behave as a trend follower. Yet when buying a compact disc (CD) or downloading music online, the individual might be very apt at buying music in one genre that later becomes popular and/or commercially successful-whether or not the individual is aware of such an aptitude—but may behave as a trend follower in other genres of music.

Trendspotters 204 can be a useful market identifier 108 product features that relate to fads, trends or investments such as identified at reference numeral 304. Like trendspotters 204, another market identifier 108 can be trendsetters 206. Trendsetters 206 can be those individuals that establish a trend by virtue of selection irrespective of later commercial success. Examples of products with these features 300 can include products such as music or clothes that include features related to fashion, aesthetic appeal and the like as illustrated by reference numeral 306. Hence, by identifying features 306 in a product, classification component 108 can determine that trendspotters 206 is an appropriate market identifier 108 for opinions.

Yet another example market identifier 108 can be experts 308. Experts over a certain market domain or product can be more relevant to products that are highly technical, sophisticated, complex, and/or utility driven (e.g., reference numeral 308) such as a car, a camera, a computer and so on. For example, Ashley may be very satisfied with Ross's opinion about a camera, however, the true grounds for this outcome might not be because Ashley and Ross are friends, but rather because Ross is a nature enthusiast and a local expert on cameras. Hence, Ross's opinions that relate to cameras might be extremely valuable to any person irrespective of some relationship with Ross, whereas Ross's opinions as to wine might be irrelevant to most everyone, including his close friend, Ashley.

Another example market identifier 108 can be tastes or traits 210 that can be relevant for products such as food or entertainment (e.g., individual tastes) as well as for, say, physical therapy (e.g., individual traits such as a medical condition). Such products generally have features 310 that relate to personal tastes and/or a specific market or audience. The final example market identifier 108 illustrated is global 212. Global identifier 212 can imply all opinions can be aggregated and is generally useful when the most relevant product feature is brand name or product recognition as noted at reference numeral 312.

While still referring to FIG. 1, it is to be appreciated that classification component 106 can determine or infer several market identifiers 108 for a single product given one or more associated product features, any one or combination of which can be employed as the most relevant or be assigned a level of relevance based upon suitable weights. Any such determination or inference (further detailed infra) about market identifier 108 and/or product features 300 can be employed by opinion aggregation component 110 to filter (e.g., in addition to or as an alternative to aggregation) an opinion associated with the product in order to select the set of opinions 112 when the opinion is insufficiently related to market identifier 108. It is to be further understood that all or portions of data received or accessible to components 102, 106, 110 can be saved to a local and/or distributed data store 114 for archival purposes such as later access or recall.

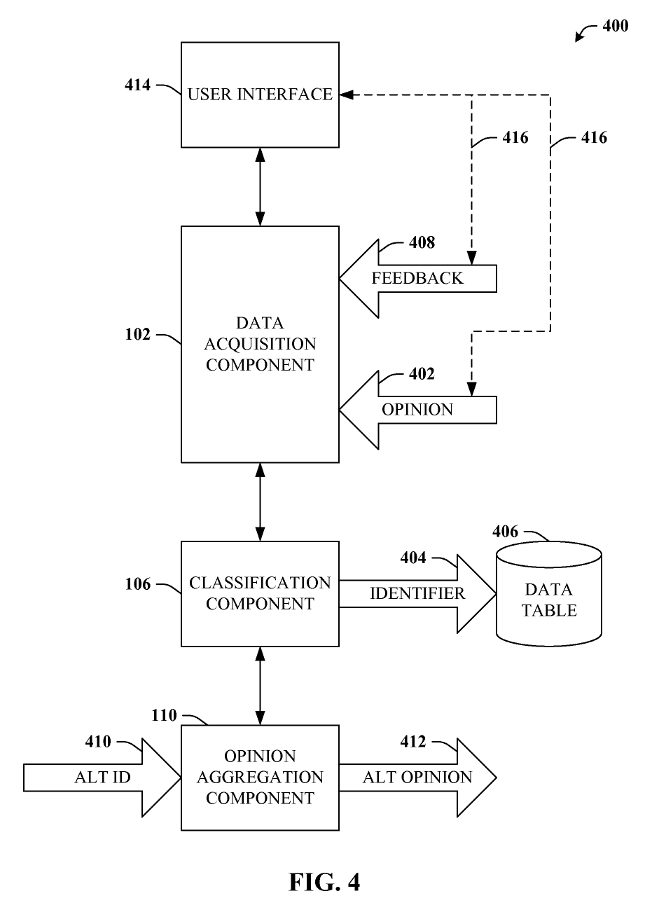

Turning now to FIG. 4, system 400 that can construct market identifiers and/or provide alternative opinion sets is illustrated. In general, system 400 can include data acquisition component 102, classification component 106, and opinion aggregation component 110 as substantially described supra. In addition to or in the alternative to the foregoing, component 102, 106, 110 can have implement other aspects of the claimed subject matter, much of which can now be described. For instance, data acquisition component 102 can obtain opinion 402, which can include information related to an opinion source (not shown).

For example, data acquisition component 102 can employ numerous techniques (e.g., data mining techniques, user feedback, and so on) to ascertain opinion 402. As one illustration, data acquisition component 102 can allow individuals to submit information, ideas, or other data. As another illustration, data acquisition component 102 can facilitate web crawls aimed at gathering information related to products or product features such as published articles, review, etc. In either case, as well as others, there is generally certain relevant information about the opinion source such as author, affiliations, qualification and so on.

As was done with respect to products, classification component 106 can further determine market identifier 404, which can be similar to market identifier 108, yet for opinions (as distinguished from products) and generally based upon information related to the opinion source. For example, if data acquisition component 102 acquires opinion 402 written by Ross, then that opinion 402 can be classified based upon the product. If the product is digital cameras, then the identifier 404 can be set to experts 208 based upon the utility/complexity feature 308 of digital cameras in connection with Ross's expertise on the subject matter. However, if the product is auto mechanics, then opinion 402 can be classified under friends identifier 202. In the later case, it is to be appreciated that any given query 104 that includes auto mechanics may or may not return Ross's opinion 402. For instance, opinion aggregation component 110 can identify that Ross's opinion 402 is within the domain of suitable opinions, but whether or not that opinion 402 is ultimately selected to be included in the set of opinions 112 can rely upon whether or not the user is a friend of Ross's (such as Ashley, for example). It is to be further appreciated that Ross could author opinion 402 for a product about which he is a technical expert, yet that opinion 402 need not be categorized under expert 208 market identifier, or at least not primarily. This situation can arise if the underlying product has been classified under a different market identifier 108, say friends 202. In that case, it should be underscored that expert opinion might have been determined to be of very low relevance for the product, so classifying Ross's opinion 402 solely as expert 208 could serve to reduce the potential application for opinion 402, rather than enhancing it.

Moreover, in addition to other types of feedback, data acquisition component 102 can also receive feedback 408 (e.g., from a user) that can relate to the accuracy, relevance, or veracity associated with the set of opinions 112 selected by opinion aggregation component 110. In accordance therewith, classification component 106 can incrementally build data table 406 that can relate the product to one or more market identifiers 108 based upon feedback 408. For instance, feedback 408 can be useful to aid classification component 106 in identifying or teasing out the dynamics of products and/or product features. Thus, products or product features can be associated with a particular market identifier 108 and/or suitably weighted. The resultant data table 406 that can link certain products or features to certain market identifiers 108 can be newly constructed or updated based upon either or both of opinion 402 or feedback 408 and can be stored to data store 114 for later access or recall such as when classification component 106 is determining the market identifier 108 in response to query 104.

Furthermore, e.g. to test various determinations or inferences, opinion aggregation component 110 can employ alternative market identifier 410 to select alternative set of opinions 412. Hence, data acquisition component 102 can obtain feedback 408 from both sets 112 and 412, which can be quite useful for subsequent determinations or inferences employed for classification of products.

In addition, system 400 can also include user interface 414, which can be substantially any suitable user interface, either hardware or software (or combinations thereof), and can further be either or both local to or remote from data acquisition component 102. User interface 414 can be the vehicle by which data acquisition component 102 receives all or portions of the data acquired such as opinion 402, feedback 408, etc. as illustrated by broken lines 416. User interface 414 can also facilitate alternative market identifier 410, by for example providing a selection input to the user.

For example, consider a user who inputs to a search engine query 104 that includes the text “digital camera.” Digital cameras are or include features 308 that can be technically complex. Hence, classification component 106 might determine that experts 208 is (one of) the relevant market identifiers 108. Accordingly, opinion aggregation component 110 can select opinions 112 that originate only from experts in the domain of digital cameras or some suitable sub-domain. In one aspect the opinions 112 can be delivered directly to the user. In another aspect, the opinions 112 can be propagated to the search engine, thereby potentially affecting the search results that might otherwise have been delivered to the user. In either case, user interface can provide a selection medium to allow the user to modify market identifier 108. Thus, the user interface can indicate that the following results are based upon opinions 112 of experts 208, but the user can click a link or a drop-down box for example to change make desired changes. Hence, the user can view results generated by the system, then change the market identifier 108 to, say, friends 202, to see what the differences would be. The user might find that friends actually produce better results and given representative feedback 408, classification component 106 can make note of this data.

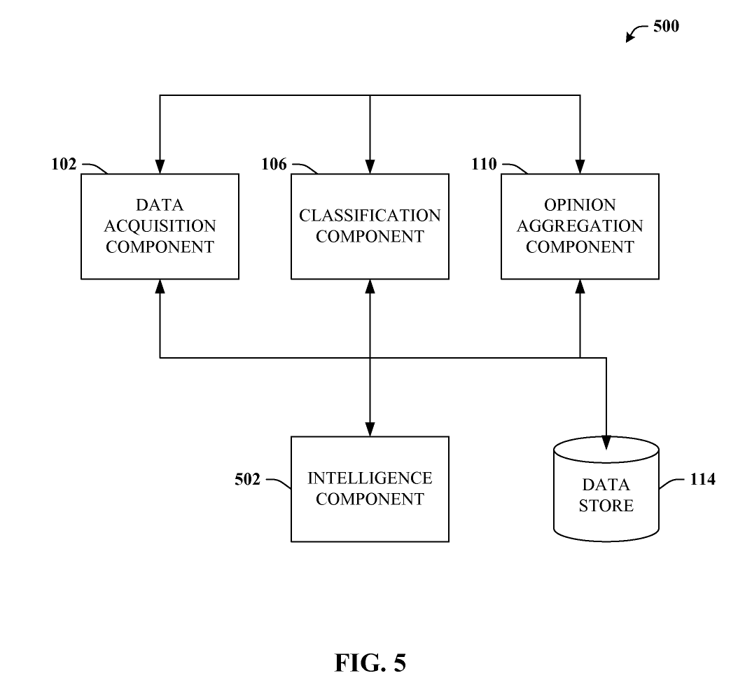

With reference now to FIG. 5, system 500 that can aid with various inferences is depicted. Generally, system 500 can include data acquisition component 102 that can, e.g. intelligently obtain, determine, or infer opinions associated with a product, information related to the opinion source, as well as other data. System 500 can also include classification component 106 that can intelligently determine or infer market identifiers 108 for products and for opinions 402 as well as other data. Opinion aggregation component 110 can intelligently determine or infer suitable alternative market identifiers 410 as well as other data such as selecting opinions 112 and utilization of information associated with a user. Data store 114 can include all data that is useful to the components described herein.

In addition, system 500 can also include intelligence component 502 that can provide for or aid in various inferences or determinations. It is to be appreciated that intelligence component 502 can be operatively coupled to all or some of the aforementioned components. Additionally or alternatively, all or portions of intelligence component 502 can be included in one or more of the components 102, 106, 110. Moreover, intelligence component 502 will typically have access to all or portions of data sets described herein, such as data store 114, and can furthermore utilized previously determined or inferred data.

Accordingly, in order to provide for or aid in the numerous inferences described herein, intelligence component 502 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, where the hypersurface attempts to split the triggering criteria from the non-triggering events. Intuitively, this makes the classification correct for testing data that is near, but not identical to training data. Other directed and undirected model classification approaches include, e.g. naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

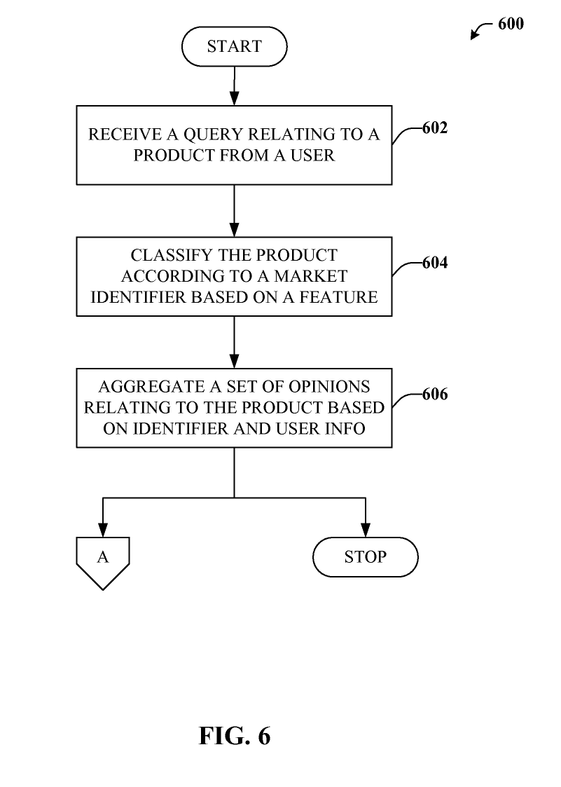

FIGS. 6, 7, and 8 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

With reference now to FIG. 6, exemplary computer implemented method 600 for aggregating opinions relating to a product based upon market categories is illustrated. Typically, at reference numeral 602, a query relating to a product can be received. Generally, the query can be received from a user and can include data relating to the user. At a minimum, the query can include a reference (e.g., textual or graphic) to a product. Hence, the query can be, but is not necessarily required to be a search string input to a search engine and/or an appropriate interface such as a search or other types of browsers that can interface with engines or other applications.

At reference numeral 604, the product can be classified according to a market identifier based upon, e.g., the product itself or a feature of the product. In other words, the market identifier can define or describe a certain category or opinion segment for which the product is associated, either by highest relevance or a combination of many relevant market identifiers. The identified category or opinion segment can be the types of opinions that are most relevant to this product. Thus, for product A, opinions from friends might be more relevant, whereas for product B, opinions from experts might be more relevant. By employing features of the product to in order to select opinions, one potentially unforeseen benefit is that less background or profile information about a user (which is often notoriously difficult to obtain) might be necessary in order to tailor or personalize opinions to a particular user.

At reference numeral 606, a set of opinions relating to the product can be aggregated based upon the market identifier and information corresponding to the user. In accordance therewith, the market identifier can provide a mechanism for identifying opinions that are more likely to be relevant to the user as well as provide a mechanism for filtering out the opinions that are more likely to be less relevant. Said another way, if the market identifier is determined to indicate opinions from experts are most relevant to a particular product for which the user is searching, say, digital cameras, then only those opinions might be selected while opinions from say friends or people with similar demographics might be filtered from selection (unless those individuals happen to be experts in the product domain or with respect to a relevant product feature). Once the set of opinions that are relevant has been ascertained, this set can be further refined based upon information associated with the user.

In the above example, no information about the user other than that contained in the query (that the user is searching for digital cameras) might be necessary, as an expert's opinion is likely relevant in this case irrespective of characteristics of the user. However, in other cases, such as when the market identifier is friends or personal traits, then other information about the user might be required. For example, even though the market identifier can restrict the set of available opinions to only those that qualify as a friends-type market identifier, it might still be necessary to know which opinions come from friends of the user in particular.

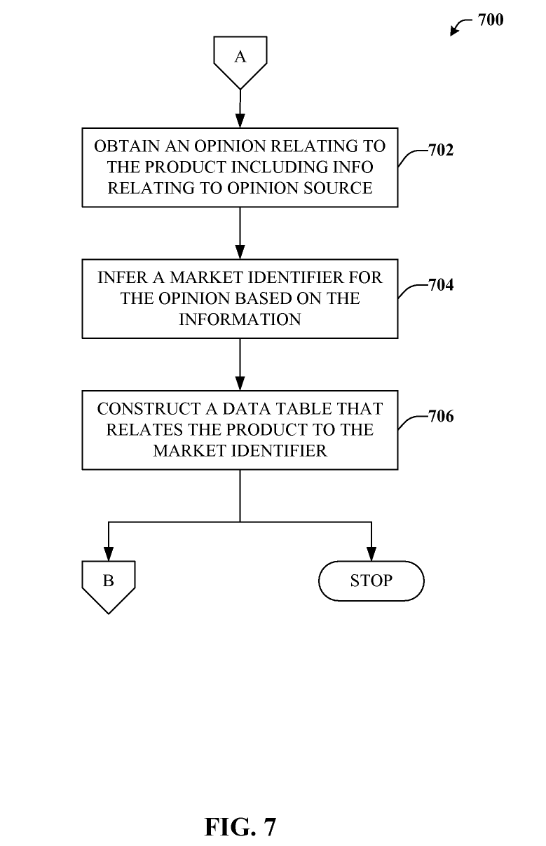

FIG. 7 depicts computer implemented method 700 for acquiring opinions and constructing a data table suitable for identifying market identifiers. At reference numeral 702, an opinion relating to the product can be obtained wherein the opinion can include information relating to an opinion source. The acquisition of opinions can be in the form of submissions from individuals (e.g., reviews, forms, surveys, wikis, etc.) as well as media examination or web-based data mining.

At reference numeral 704, a market identifier can be inferred for the opinion based upon the information relating to the opinion source acquired at act 702. For example, if the opinion was created by an expert on the product or related features, then that opinion can conceivably be classified under expert market identifier. At reference numeral 706, a data table that relates the product to the market identifier can be constructed. Construction of the data table can be facilitated by various data mining techniques, empirical data, trial and error and/or data comparison. The data table can be employed for product/feature lookup for later identification of market identifiers assigned to query inputs.

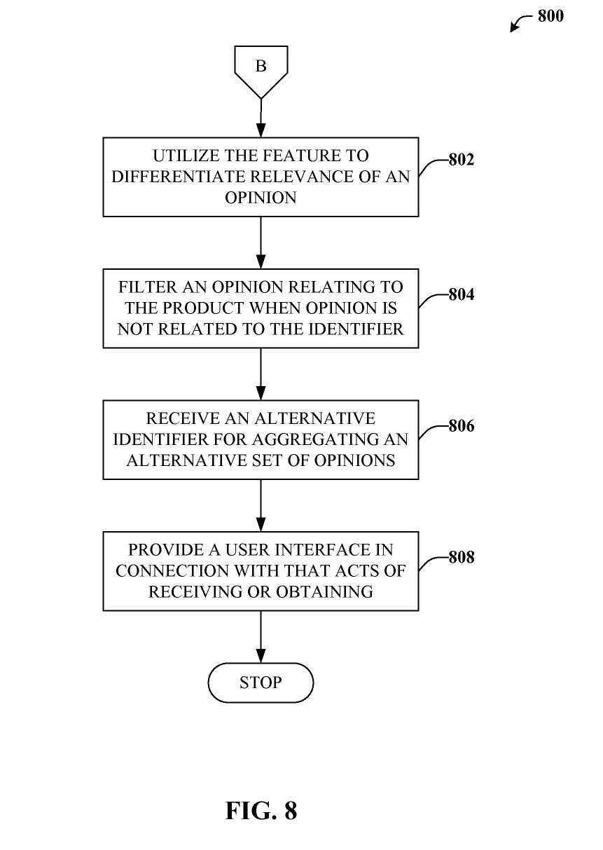

Turning briefly to FIG. 8, computer implemented method 800 for providing additional aspects or features is provided. Typically, at reference numeral 802, the feature of the product can be utilized to differentiate relevance of an opinion associated with the product. For example, the act of classifying described at reference numeral 604 can assign values or weights to various opinions. At reference numeral 804, an opinion relating to the product can be filtered when the opinion is not adequately related to the market identifier in connection with the act of aggregating referred to at reference numeral 606. Thus, in addition to strict aggregation, relevant opinions can be selected by employing a filtering mechanism as well.

At reference numeral 806, an alternative market identifier can be received. The alternative market identifier can be employed for, e.g. aggregating an alternative set of opinions. In turn, aggregating an alternative set of opinions can be utilized in connection with quality control as well, model testing, as for providing additional features to a user. At reference numeral 808, a user interface can be provided in connection with the acts of receiving or obtaining. Hence, reference numerals 602, 702, and 806, supra can, respectively, utilize the user interface to receive the query, obtain an opinion, or receive an alternative opinion.

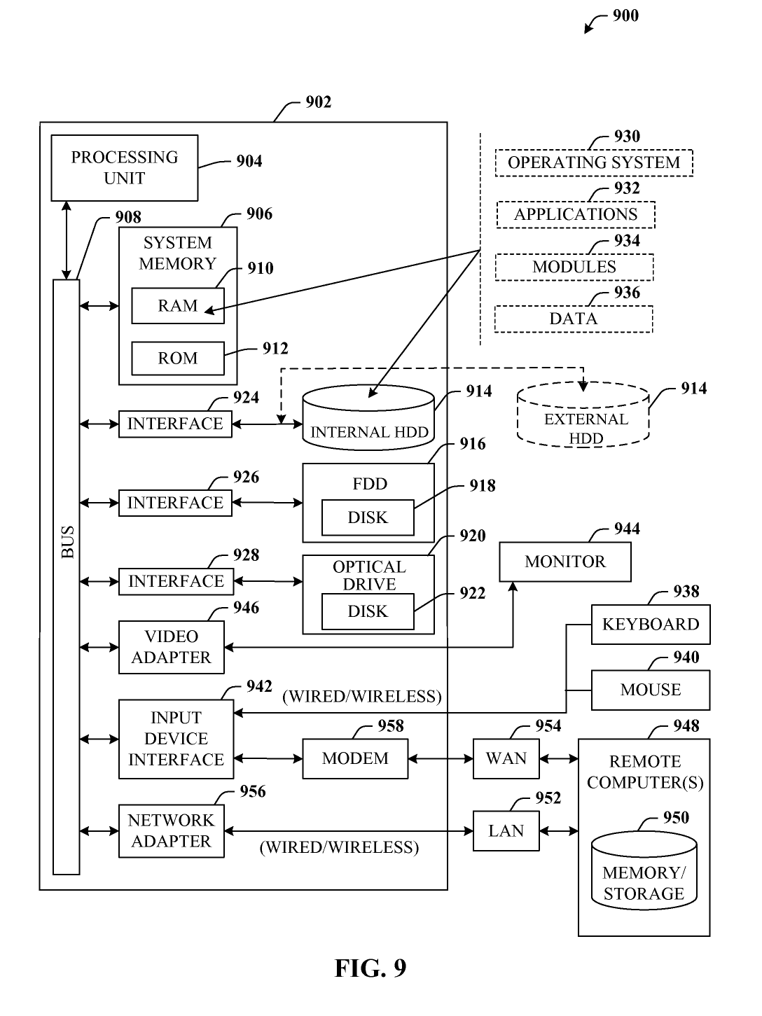

Referring now to FIG. 9, there is illustrated a block diagram of an exemplary computer system operable to execute the disclosed architecture. In order to provide additional context for various aspects of the claimed subject matter, FIG. 9 and the following discussion are intended to provide a brief, general description of a suitable computing environment 900 in which the various aspects of the claimed subject matter can be implemented. Additionally, while the claimed subject matter described above may be suitable for application in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the claimed subject matter includes a computer 902, the computer 902 including a processing unit 904, a system memory 906 and a system bus 908. The system bus 908 couples to system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g. reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the claimed subject matter can be implemented with various commercially available operating systems or combinations of operating systems.

A user can enter commands and information into the computer 902 through one or more wired/wireless input devices, e.g. a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g. the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11b) or 54 Mbps (802.11a) data rate, for example, or with products that contain both bands (dual band), so the networks can provide real-world performance similar to the basic 10BaseT wired Ethernet networks used in many offices.

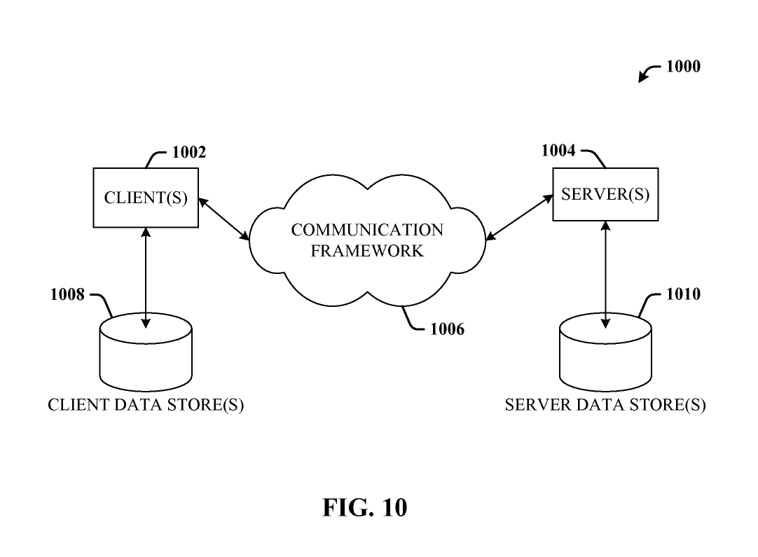

Referring now to FIG. 10, there is illustrated a schematic block diagram of an exemplary computer compilation system operable to execute the disclosed architecture. The system 1000 includes one or more client(s) 1002. The client(s) 1002 can be hardware and/or software (e.g., threads, processes, computing devices). The client(s) 1002 can house cookie(s) and/or associated contextual information by employing the claimed subject matter, for example.

The system 1000 also includes one or more server(s) 1004. The server(s) 1004 can also be hardware and/or software (e.g., threads, processes, computing devices). The servers 1004 can house threads to perform transformations by employing the claimed subject matter, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A computer implemented system that employs product classifications to aggregate opinions associated with a product, comprising:
a data acquisition component that receives a query from a user, the query is associated with a product;
a classification component that determines a market identifier for the product based at least in part upon a feature of the product; and
an opinion aggregation component that selects a set of opinions related to the market identifier based upon information associated with the user.

2. The system of claim 1, the classification component employs the feature to distinguish relevance of an opinion associated with the product.

3. The system of claim 1, the market identifier is a classification in which an opinion associated with the product is most relevant.

4. The system of claim 1, the market identifier is at least one of friends, trendspotters, trendsetters, experts, similar traits, global, or a combination thereof.

5. The system of claim 1, the feature of the product is at least one of a risk of defection, a good, a service, a location, informational or knowledge-based, an availability of information, a market domain, a market dynamic, aesthetic value, fashion, a trend, an investment potential, utility-driven, a technical complexity, related to personal tastes or a specific market or audience, a brand name, product recognition, or a combination thereof.

6. The system of claim 1, the opinion aggregation component filters an opinion associated with the product in order to select the set of opinions when the opinion is insufficiently related to the market identifier.

7. The system of claim 1, the data acquisition component obtains an opinion associated with the product, the opinion includes information related to an opinion source.

8. The system of claim 7, the classification component determines a market identifier for the opinion based upon the information related to the source.

9. The system of claim 1, the data acquisition component obtains feedback from the user with respect to an accuracy or a relevance associated with the set of opinions.

10. The system of claim 9, the classification component incrementally builds a data table that relates the product to the market identifier based upon the feedback.

11. The system of claim 1, the opinion aggregation component employs an alternative market identifier to select an alternative set of opinions and the data acquisition component obtains feedback with respect to an accuracy or a relevance associated with the alternative set of opinions.

12. The system of claim 11, the classification component incrementally builds a data table that relates the product to the market identifier based upon the feedback.

13. The system of claim 1, further comprising a user interface that receives the query from the user, supplies the set of opinions to the user, or receives the opinion from an opinion source.

14. The system of claim 13, the user interface facilitates an alternative market identifier provided by the user.

15. A computer implemented method for aggregating opinions relating to a product based upon market categories, comprising:
receiving a query relating to a product from a user;
classifying the product according to a market identifier based upon a feature of the product; and
aggregating a set of opinions relating to the product based upon the market identifier and information corresponding to the user.

16. The method of claim 15, the market identifier is at least one of friends, trendspotters, trendsetters, experts, similar traits, global, or a combination thereof.

17. The method of claim 15, the feature of the product is at least one of a risk of defection, a good, a service, a location, informational or knowledge-based, an availability of information, a market domain, a market dynamic, aesthetic value, fashion, a trend, an investment potential, utility-driven, a technical complexity, related to personal tastes or a specific market or audience, a brand name, product recognition, or a combination thereof.

18. The method of claim 15, further comprising at least one of the following acts:
obtaining an opinion relating to the product, the opinion including information relating to an opinion source;
inferring a market identifier for the opinion based upon the information relating to the opinion source; or
constructing a data table that relates the product to the market identifier.

19. The method of claim 18, further comprising at least one of the following acts:
utilizing the feature of the product to differentiate relevance of an opinion associated with the product;
filtering an opinion relating to the product when the opinion is not adequately related to the market identifier in connection with the act of aggregating;
receiving an alternative market identifier for aggregating an alternative set of opinions; or
providing a user interface in connection with the acts of receiving or obtaining.

20. A computer implemented system for choosing opinions relating to a product by utilizing market classifications, comprising:
computer implemented means for obtaining from a user a query relating to a product;
computer implemented means for categorizing the product in accordance with a market identifier related to a feature of the product; and
computer implemented means for employing the market identifier and information corresponding to the user to select a set of opinions about a product.
